(19) United States
(12) Patent Application Publication
(10) Pub. No.: US 2026/0365387 A1
(43) Pub. Date: Nov. 19, 2026

(54) DEVICE FOR PACKAGING AND DISPENSING COSMETIC PRODUCT, AND ASSOCIATED METHOD OF USE

(71) Applicant: L'OREAL, Paris (FR)

(72) Inventors: Gabriel EVAIN, Clichy (FR); Laurent AUBRY, Clichy (FR)

(73) Assignee: L'OREAL, Paris (FR)

(21) Appl. No.: 19/477,555

(22) PCT Filed: Mar. 1, 2024
(86) PCT No.: PCT/EP2024/055374

§ 371 Date: Oct. 22, 2025

(30) Foreign Application Priority Data
Apr. 27, 2023 (FR) FR2304272

(51) Int. Cl. B65D 47/18; B05B 11/04

(52) U.S. Cl. CPC B65D 47/18; B05B 11/047

(57) ABSTRACT

The device (10) comprises:
a container (12) comprising a reservoir (20) containing a cosmetic product (14) and a neck (22) defining a dispensing passage (36),
a dispensing tip (16) mounted tightly in the dispensing passage (36) and defining a dispensing channel between an upstream inlet and a downstream orifice.

The cosmetic product (14) has a viscosity between 0.001 Pa·s and 1.5 Pa·s, the dispensing channel being cleared between the upstream inlet and the downstream orifice and including at least one regulation region for regulating the cosmetic product flow having a transverse span in relation to an axis of the channel, less than 2 mm over a height measured in projection along an axis parallel with the axis of the channel of at least 5 mm.

This invention relates to a device for packaging and dispensing cosmetic product, comprising:
a container comprising a reservoir containing a cosmetic product and a neck having a cylindrical downstream region defining a dispensing passage for the cosmetic product,
a convergent dispensing tip from the reservoir to a downstream orifice, the dispensing tip being tightly mounted in the dispensing passage and defining a dispensing channel for the cosmetic product having an upstream inlet opening toward the reservoir and discharging downstream via the downstream orifice.

The cosmetic product is for example a hair product, a hygiene product, a facial and/or body care product, a makeup product, or a sun protection product.

More generally, a cosmetic product is a product as defined in EC Regulation No. 1223/2009 of the European Parliament and the Council of Nov. 30, 2009, relating to cosmetic products.

For numerous applications in makeup, hair products or care, it is necessary to precisely apply a controlled dose of cosmetic product on a body surface. This application is generally performed by pressing the deformable walls of a container containing the product and retrieving the product at the outlet of a tip.

Such an application is sometimes rendered difficult, in particular according to the viscosity of the product delivered, which may vary significantly from one product to another, and the type of packaging device which may be more or less rigid.

It is then frequent that a user encounters difficulty obtaining a sufficient dose of product by having to deploy a substantial compression force of the packaging device. On the other hand, applying an excessive compression force may result in excess product being delivered, with sometimes difficulties retracting it inside the container.

From WO 2015/028733, a device for packaging and applying a makeup composition is known comprising a flexible tube container having a composition flow cross-section between the container and the dispensing orifice between 0.2 mm² and 3 mm² in area, allowing regular and controlled dispensing of the composition on an application surface.

Further cosmetic product packaging and dispensing devices are described in JP05319446, US20040245290, U.S. Pat. No. 7,758,553, and US20210244157.

However, such devices may be improved further, in particular to facilitate the dosing of the product further by obtaining a regular product flow.

An aim of the invention is that of providing a device for packaging and dispensing a cosmetic product, enabling a user to readily control the flow and easily and precisely dose the quantity of cosmetic product at the outlet.

To this end, the invention relates to a device for packaging and dispensing a cosmetic product of the type cited above, characterized in that the cosmetic product has a viscosity between 0.001 Pa·s and 1.5 Pa·s, the dispensing channel being cleared between the upstream inlet and the downstream orifice, the dispensing channel including at least one regulation region for regulating the cosmetic product flow having a transverse span D3 in relation to an axis of the channel, less than 2 mm over a height H1 measured in projection along an axis parallel with the axis of the channel of at least 5 mm, preferably at least 10 mm.

Surprisingly, combining very specific geometric parameters for the dispensing channel, with a viscosity adapted to the cosmetic product used, offers precise control of the flow and quantity of the product delivered, without a risk of excessive dispensing and without having to deploy an excessive force to obtain the desired dose of product.

According to a variant, the device for packaging and dispensing a cosmetic product according to the invention comprises the following feature:
the dispensing channel is of conical shape, the ratio of the minimum transverse span to the maximum transverse span being between 0.6 and 1.

The slightly conical geometry of the dispensing channel precisely regulates the flow of product circulating in the dispensing channel and hence helps deliver a precise and controlled dose of product at the outlet of the dispensing channel.

According to a variant, the device for packaging and dispensing a cosmetic product according to the invention comprises the following feature:
the downstream orifice located downstream from the regulation region has an angular outlet aperture greater than 15°, in particular greater than 45°.

The wide angular outlet aperture of the orifice slows down the velocity of the product at the outlet of the dispensing channel, ensuring moderate dispensing, and prevents where applicable undesired excess material from obstructing the outlet of the dispensing channel.

According to a variant, the device for packaging and dispensing a cosmetic product according to the invention comprises the following feature:
the reservoir includes at least one side wall and a bottom, the side wall having a minimum mean deformation greater than 1 mm when a force of 30 N is applied at the geometric center of the wall, with a preloading rate of 20 mm/min, the minimum mean deformation being in particular greater than 2 mm, and in particular between 3 mm and 5 mm.

The presence of a side wall having the deformation features as described above enables the reservoir to be flexible and readily compressed by the user by pressure on the walls to deliver the desired dose of cosmetic product.

According to a variant, the device for packaging and dispensing a cosmetic product according to the invention comprises the following feature:
the reservoir includes at least one side wall and a bottom, the side wall having a mean lack of springback greater than −8% when a force of 30 N is applied at the geometric center of the wall, with a preloading rate of 20 mm/min, the mean lack of springback being in particular greater than −3%, and in particular between −1% and 0%.

When the walls of the reservoir are deformed by the user who applies a pressure, then releases the pressure applied, their elasticity enables them, on one hand, to return to their initial shape and avoid permanent deformation of the reservoir, and, on the other, to generate a suction effect which optionally aspirates the excess cosmetic product inside the reservoir. The user can then precisely dose the quantity of product that is delivered.

According to a variant, the device for packaging and dispensing a cosmetic product according to the invention comprises the following feature:
the minimum mean deformation of the side wall is between 3 mm and 5 mm, and the mean lack of springback of the side wall is between −1% and 0%.

The combination of the features of deformability and elasticity of the walls of the reservoir optimizes the use of the packaging and storage device, both thanks to a more readily implemented and controlled delivery and provides a more clearly defined dispensing, without delivering excess product.

According to a variant, the device for packaging and dispensing a cosmetic product according to the invention comprises the following feature:
the reservoir is made of plastic material selected from polypropylene, polyethylene terephthalate, and high-density polyethylene.

The plastic materials used to form the reservoir have an adapted flexibility, giving its appropriate mechanical properties for application.

According to a variant, the device for packaging and dispensing a cosmetic product according to the invention comprises either of the following features:
the reservoir is at least partially transparent, preferably completely transparent;
the dispensing tip is made of an at least partially transparent, preferably completely transparent, material.

The partial or complete transparency of the reservoir and/or of the tip enables better visual dosing of the quantity of product delivered and involves an esthetic effect where the user can see the cosmetic product through the packaging and dispensing device.

According to a variant, the device for packaging and dispensing a cosmetic product according to the invention comprises the following feature:
the dispensing tip includes a plurality of ribs for guiding product toward the dispensing channel.

The presence of a plurality of guiding ribs in the tip for dispensing the cosmetic product toward the dispensing channel makes it possible, in the case where beads are used to homogenize a product capable of separating into phases, to keep the beads away from the outlet channel so as not to obstruct it. Moreover, the ribs add an esthetic aspect to the dispensing tip in the case where it is partially or completely transparent.

The invention also relates to a method for using such a device for packaging and dispensing a cosmetic product comprising the following steps:
providing a cosmetic product packaging and dispensing device as described above,
pressing by the user on a side wall of the reservoir with a force less than or equal to 30 N,
delivering at least one dose of cosmetic product on the body surface.

Further features and advantages of the invention will emerge after reading the following description given solely as an example with reference to the appended drawings in which:

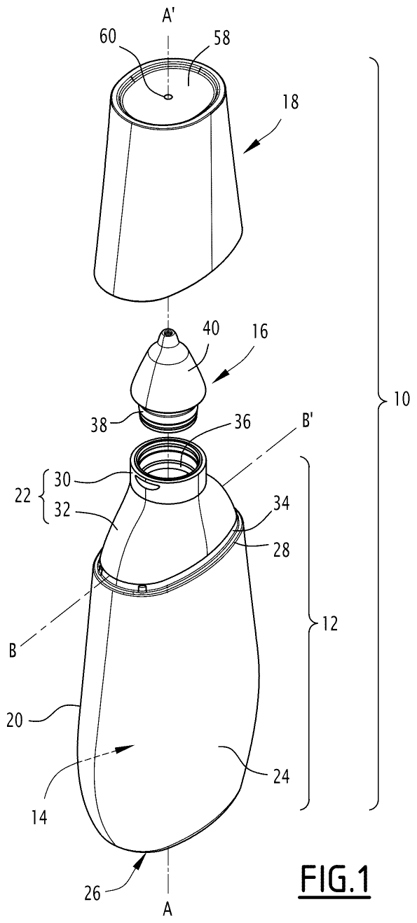

FIG. 1 is an exploded perspective view of a first product packaging and dispensing device comprising a container and a dispensing tip,

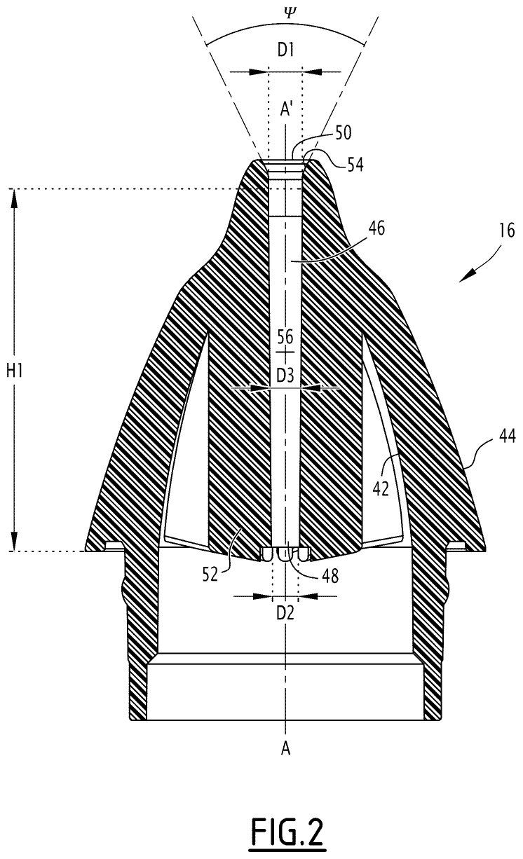

FIG. 2 is a view of a first dispensing tip, as a cross-section along a median vertical plane containing a central axis of the tip, and

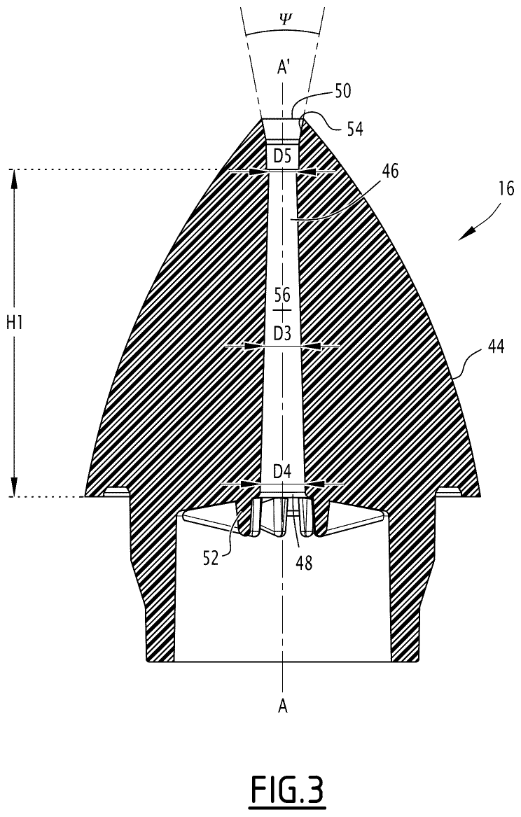

FIG. 3 is a view of a second dispensing tip, as a cross-section along a median vertical plane containing a central axis of the tip.

Hereinafter, the terms “upstream” and “downstream” are understood generally with respect to the normal direction of dispensing of the product during use.

A device 10 for packaging and dispensing a cosmetic product according to the invention is illustrated in FIG. 1.

The device 10 extends here along a central axis A-A′ shown as vertical in FIG. 1.

The packaging and dispensing device 10 comprises a container 12, a cosmetic product 14 contained in the container 12, a tip 16 for dispensing the cosmetic product out of the container 12. In this example, the device 10 also includes a cap 18 closing the container 12 in the downstream direction, at the top of FIG. 1.

The cosmetic product 14 is for example a hair product, a hygiene product, a facial and/or body care product, a makeup product, or a sun protection product.

The cosmetic product has according to the invention a viscosity between 0.001 Pa·s and 1.5 Pa·s.

The viscosity of the cosmetic product is for example measured at 25 °C using a Rheomat 180 (LAMY) equipped with an MS-R1, MS-R2, MS-R3, MS-R4 or MS-R5 spindle selected according to the consistency of the cosmetic product, rotating at a rotational speed of 200 rpm. The measurement is taken after 10 min of rotation. The viscosity measurements are made at most 1 week after manufacturing the cosmetic product 14.

The container comprises a reservoir 20 and a neck 22.

The reservoir 20 is made of polymer, in particular selected from polypropylene, high-density polyethylene and polyethylene terephthalate. The reservoir 20 is advantageously partially or completely transparent. The term transparent means that the interior of the reservoir 20 is visible to the naked eye from the exterior of the reservoir 20.

The reservoir 20 here has a side wall 24, a bottom 26, and a downstream edge 28. The reservoir 20 has in this example an elongated contour along an elongation axis B-B′ perpendicular to the central axis A-A′.

The internal volume of the reservoir 20 is greater than 10 mL and is for example between 15 mL and 100 mL.

The side wall 24 of the reservoir 20 has a minimum mean deformation greater than 1 mm when a force of 30 N is applied at the geometric center of the side wall 24, with a preloading rate of 20 mm/min. The geometric center is taken in projection in a vertical plane, the bottom 26 being placed on a horizontal surface. The minimum mean deformation is advantageously greater than 2 mm, and is in particular between 3 mm and 5 mm in projection in a vertical plane.

The deformation of the side wall 24 subjected to the force of 30 N is measured at 25 °C as the difference in height of the reservoir 20 when it is lying on the side wall 24, between a pre-deformation configuration and a deformed configuration when the force applied has reached 30 N. Three tests are performed on each side of the side wall 24 and a mean deformation in millimeters is calculated for the reservoir 20.

The side wall 24 of the reservoir 20 also has a mean lack of springback greater than −8%, after applying a force of 30 N at the geometric center of the side wall 24 with a preloading rate of 20 mm/min. As above, the geometric center is taken in projection in a vertical plane on the wall, the bottom 26 being placed on a horizontal surface.

Advantageously, the mean lack of springback is greater than −3%, and in particular between −1% and 0%.

The lack of springback is measured as the residual deformation of the side wall 24 of the reservoir 20 as a percentage after releasing the force of 30 N, during the tests performed as above. Three tests are performed on each side of the side wall 24 and the mean lack of springback is determined on the reservoir 20.

Advantageously, the side wall 24 has a minimum mean deformation greater than 1 mm and a mean lack of springback greater than −8% when a force of 30 N is applied at the geometric center of the wall with a preloading rate of 20 mm/min. Advantageously, the minimum mean deformation is between 3 mm and 5 mm, the mean lack of springback being in particular between −1% and 0%.

In the example shown in FIG. 1, the neck 22 comprises a cylindrical downstream region 30 and an upstream region 32 flaring in the upstream direction from the downstream region 30, up to an upstream edge 34 extending the downstream edge 28 of the reservoir 20.

The downstream region 30 is cylindrical about the central axis A-A′ which is vertical in FIG. 1.

The cylindrical downstream region 30 defines an inner dispensing passage 36 wherein the cosmetic product 14 flows before being dispensed.

In this specific example, the upstream edge 34 of the upstream region 32 has an elongated contour along the elongation axis B-B′ perpendicular to the central axis A-A′. In this example, the contour of the upstream edge 34 is oblong and has two end segments connected by two transverse segments of greater curvature than that of the end segments. The upstream edge 34 and the downstream edge 28 defines a shoulder for supporting the cap 18.

As seen in FIG. 1, the dispensing tip 16 is mounted tightly in the inner dispensing passage 36 of the neck 22.

The dispensing tip 16 dispenses the cosmetic product downstream from the inner dispensing passage 36. The dispensing tip 16 has a cylindrical upstream region 38, as seen in FIGS. 1 and 2, engaged tightly in the inner dispensing passage 36 and a downstream region 40 of convergent shape in the downstream direction, for example of truncated shape, projecting axially beyond the neck 22.

The downstream region 40 of convergent shape is formed by an outer skirt which comprises an inner surface 42 and an outer surface 44, as seen in FIG. 2.

The dispensing tip 16 is advantageously partially or completely transparent. The term transparent means that the interior of the tip 16 is visible to the naked eye from the exterior of the tip 16.

The dispensing tip 16 includes a dispensing channel 46 of the cosmetic product 14 defined by an inner cylindrical skirt extending in the outer skirt. The dispensing channel 46 extends between an upstream inlet 48 and a downstream orifice 50.

The dispensing tip 16 includes ribs 52 for supporting the channel and guiding the cosmetic product inserted between the inner skirt and the outer skirt.

The support ribs 52 include, from the outer skirt defining the dispensing channel 46 to the inner surface 42, a first radial portion in relation to the axis A-A′ projecting axially from the dispensing channel and a second curved portion connecting the radial portion to the inner surface 42.

Each support rib 52 connects the inner skirt to the inner surface 42. The support ribs 52 are distributed in such a way as to form, for example, a helix inside the dispensing tip 16.

The support ribs 52 project upstream from the upstream inlet 48 of the dispensing channel 46 as seen in FIG. 2.

In the example where the dispensing tip 16 is partially or completely transparent, the support ribs 52 add an esthetic effect.

The dispensing channel 46 extends axially along the axis A-A′ and is completely cleared between the upstream inlet 48 and the downstream outlet orifice 50.

In the example of FIG. 2, the dispensing channel 46 is of conical shape, flaring from the upstream inlet 48 to the downstream orifice 50. It has a maximum transverse span D1 at the downstream orifice 50 and a minimum transverse span D2 at the upstream inlet 48. The ratio of the minimum transverse span D2 to the maximum transverse span D1 is for example between 0.6 and 1.

The downstream outlet orifice 50 forms a downstream flaring 54 having an angular span ψ greater than 15°, in particular greater than 45° in relation to the axis A-A′ of the dispensing channel 46.

The dispensing channel 46 includes upstream from the downstream orifice 50 a regulation region 56 for regulating the cosmetic product flow extending along the axis A-A′.

The regulation region 56 has a transverse span D3 in relation to the axis A-A′ less than 2 mm over a height H1 measured in projection along the axis A-A′ of at least 5 mm, for example greater than 10 mm.

The area of the cross-section of the dispensing channel 46 in the regulation region 56 is less than 2 mm² and is in particular between 0.7 mm² and 1.5 mm².

The closing cap 18, seen in FIG. 1, is detachably mounted on the neck 22 between a mounted position on the neck 22, wherein the cap 18 covers the dispensing tip 16 and the cylindrical downstream region 30, and a removed position, freeing the dispensing tip 16.

The cap 18 defines here an outer closing cap 58 of oblong shape, elongated along the axis B-B′.

The cap 22 includes an axial sealing dog point 60 projecting in the upstream direction from the center of the closing wall 58. The dog point 60 is inserted tightly into the downstream dispensing orifice 50 when the cap 18 occupies its mounted position on the neck 22.

To use the device, the closing cap 18 is switched from its mounted position to its removed position.

The user then applies a pressure on the side wall 24 of the reservoir 20. The cosmetic product 14 is pushed and directed toward the dispensing tip 16 toward an application body surface such as the back of the hand or finger.

The flexibility of the side wall 24 of the reservoir 20, combined with the dimensions of the inner dispensing passage 36 and with the specific viscosity of the cosmetic product 14 enables the user to supply a sufficient pressure, but however without requiring an excessive force in order to dispense the cosmetic product 14.

The dimensions of the cosmetic product flow regulation region 56, as well as the geometry of the downstream orifice 50 of the dispensing tip 16 ensure precise and controlled dispensing of the product.

When the user has delivered the desired dose of cosmetic product 14, they release the pressure applied on the side wall 24 of the reservoir 20. By springback of the side wall 24 of the reservoir 20, the reservoir 20 returns to its initial shape and by suction effect aspirates the excess cosmetic product 14 inside the reservoir 20. The dispensing tip 16 thus remains clean, with no excess product deposited and wasted around the tip.

After use, the closing cap 18 is put back in its mounted position on the neck 22.

By way of example, several tests were carried out.

TABLE 1

| Test 1 | Test 2 | | | |
|---|---|---|---|---|
| 3.04 | 4.43 | Mean | PET 7.5 g | PET |
| −0.65% | 0.22 | Spring effect | | |
| | 2.24 | Mean | PET 8.5 g | |
| | −0.12% | Spring effect | | |
| 1.72 | | Mean | PET 9 g | |
| −0.96% | | Spring effect | | |
| | 1.11 | Mean | PET 10.2 g | |
| | 0.11% | Spring effect | | |
| | 4.46 | Mean | HDPE 7.3 g | HDPE |
| | −0.90% | Spring effect | | |
| 3.20 | | Mean | HDPE 7.8 g | |
| −5.86% | | Spring effect | | |
| | 3.21 | Mean | PPc 7.15 g | PP |
| | −6.87% | Spring effect | | |
| 3.57 | | Mean | PPc 7.8 g | |
| −2.25% | | Spring effect | | |

Mechanical tests on polyethylene terephthalate, high-density polyethylene and polypropylene were carried out. For each material, several reservoirs 20 distinguished by the thickness of their side wall 24, and therefore by their mass, were tested.

A force of 30 N is applied at the geometric center of the side wall 24 of the reservoir 20 in vertical projection with a preloading rate of 20 mm/min. A measurement of the deformation of the side wall 24 subjected to the force of 30 N was recorded.

As specified above, three tests were performed on each side of the reservoir 20 and a mean deformation in millimeters was calculated for each reservoir 20 characterized by a material and a specific mass (“mean” column in Tableau 1).

Similarly, the mean lack of springback was determined on each reservoir 20. The lack of springback (“spring effect” column in Tableau 1) corresponds to the residual deformation of the side wall 24 of the reservoir 20 as a percentage after releasing the force of 30 N.

A sufficient deformation of the side wall 24 of the reservoir 20, combined with a lower residual plastic deformation, makes it possible not only for the user not to have to deploy an excessive force to compress the reservoir 20 and thus deliver the cosmetic product 14, but also to deliver a precise quantity of cosmetic product 14 in a controlled manner. The springback of the side walls 24 induces a suction effect of the residual cosmetic product 14 which is aspirated inside the reservoir 20 when the user releases the pressure. Better dosing of the delivered quantity is thus obtained and the dispensing tip 16 is kept clean, with no excess product filling the downstream outlet orifice 50.

TABLE 2

| Type of | | | | |
|---|---|---|---|---|
| cosmetic | Viscosity | | Flow | Restitution |
| product | (Pa · s) | Bottle | control | rate |
| Makeup | 1.48 | PET 7.5 g | OK | |
| Skin care | 1.36 | PET 9 g | OK | |
| Skin care | 1.36 | PET 9 g | OK | |
| Skin care | 0.94 | PET 9 g | OK | |
| Makeup | 0.94 | PET 7.5 and 9 g | OK | 95% |
| Makeup | 0.86 | PET 9 g | OK | 96% |
| Skin care | 0.86 | PET 9 g | OK | |
| Skin care | 0.82 | PET 9 g | OK | |
| Skin care | 0.328 | PET 9 g | OK | |
| Makeup | 0.312 | PET 9 g | OK | |
| Skin care | 0.286 | PET 9 g | OK | |
| Skin care | 0.245 | PET 9 g | OK | |
| Skin care | 0.245 | PET 9 g | OK | |
| Skin care | 0.1 | PET 9 g | OK | |
| Hair care | 0.093 | PET 9 g | OK | |
| Hair care | 0.067 | PET 9 g | OK | |
| Water (reference) | 0.00089 | PET 9 | | 100% |

Dispensing tests were carried out on different types of cosmetic products (moisturizing cream, foundations, serums, hair care, etc.) having viscosities ranging from 0.001 Pa·s to 1.5 Pa·s.

Containers 12, of varied masses, including a reservoir 20 made of polyethylene terephthalate were used to package and dispense the cosmetic product 14.

At the geometric center of the side wall 24 of the reservoir 20 in a vertical projection, a preliminary force of 5 N is applied with a preloading rate of 20 mm/min, then a force of 30 N is applied with a preloading rate of 165 mm/min. Ten loading and unloading cycles are performed. The controllability of the flow of cosmetic product 14 dispensed and the restitution rate corresponding to the quantity of product redelivered in relation to a desired dose were determined and are recorded in Table 2.

The viscosity range from 0.001 Pa·s to 1.5 Pa·s shows satisfactory results both in terms of product flow control and restitution rate.

According to a second embodiment, shown in FIG. 3, the dispensing channel 46 is of conical shape, flaring from the downstream orifice 50 to the upstream inlet 48 and having a maximum transverse span D4 at the upstream inlet 48 and a minimum transverse span D5 at the downstream orifice 50. The ratio of the minimum transverse span D5 to the maximum transverse span D4 is for example between 0.6 and 1.

1. A device for packaging and dispensing cosmetic product, comprising:
a container comprising a reservoir containing a cosmetic product and a neck having a cylindrical downstream region defining a dispensing passage for the cosmetic product,
a convergent dispensing tip from the reservoir to a downstream orifice, the dispensing tip being tightly mounted in the dispensing passage and defining a dispensing channel for the cosmetic product having an upstream inlet opening toward the reservoir and discharging downstream via the downstream orifice,
wherein the cosmetic product has a viscosity between 0.001 Pa·s and 1.5 Pa·s, the dispensing channel being cleared between the upstream inlet and the downstream orifice, the dispensing channel including at least one regulation region for regulating the cosmetic product flow having a transverse span D3 in relation to an axis of the channel, less than 2 mm over a height H1 measured in projection along an axis parallel with the axis of the channel of at least 5 mm.

2. The device for packaging and dispensing cosmetic product according to claim 1, wherein the dispensing channel is of conical shape, the ratio of the minimum transverse span (D2; D5) to the maximum transverse span (D1; D4) being between 0.6 and 1.

3. The device for packaging and dispensing cosmetic product according to claim 1, wherein the downstream orifice (50) located downstream from the regulation region (56) has an angular outlet aperture (ψ) greater than 15°.

4. The device for packaging and dispensing cosmetic product according to claim 1, wherein the reservoir includes at least one side wall and a bottom, the side wall having a minimum mean deformation greater than 1 mm when a force of 30 N is applied at the geometric center of the wall, with a preloading rate of 20 mm/min.

5. The device for packaging and dispensing cosmetic product according to claim 1, wherein the reservoir includes at least one side wall and a bottom, the side wall having a mean lack of springback greater than −8% when a force of 30 N is applied at the geometric center of the wall, with a preloading rate of 20 mm/min.

6. The device for packaging and dispensing cosmetic product according to claim 4, wherein the side wall has a mean lack of springback greater than −8% when a force of 30 N is applied at the geometric center of the wall, with a preloading rate of 20 mm/min, and wherein the minimum mean deformation of the side wall is between 3 mm and 5 mm, and the mean lack of springback of the side wall is between −1% and 0%.

7. The device for packaging and dispensing cosmetic product according to claim 1, wherein the reservoir is made of plastic material selected from polypropylene, polyethylene terephthalate, and high-density polyethylene.

8. The device for packaging and dispensing cosmetic product according to claim 1 wherein the reservoir is at least partially transparent.

9. The device for packaging and dispensing cosmetic product according to claim 1, wherein the dispensing tip is made of at least partially transparent.

10. The device for packaging and dispensing cosmetic product according to claim 1, wherein the dispensing tip includes a plurality of ribs for guiding cosmetic product toward the dispensing channel.

11. A method for dispensing cosmetic product on a body surface, comprising the following steps:
providing a device for packaging and dispensing cosmetic product according to claim 1,
pressing by the user on a side wall of the reservoir with a force less than or equal to 30 N,
delivering at least one dose of cosmetic product on the body surface.

12. The method according to claim 11, wherein the release of the pressure exerted by the user induces the retraction of the cosmetic product by springback of the side wall deformed by the user.

13. The device for packaging and dispensing cosmetic product according to claim 2, wherein the downstream orifice located downstream from the regulation region has an angular outlet aperture (ψ) greater than 15°.

14. The device for packaging and dispensing cosmetic product according to claim 2, wherein the reservoir includes at least one side wall and a bottom, the side wall having a minimum mean deformation greater than 1 mm when a force of 30 N is applied at the geometric center of the wall, with a preloading rate of 20 mm/min.

15. The device for packaging and dispensing cosmetic product according to claim 3, wherein the reservoir includes at least one side wall and a bottom, the side wall having a minimum mean deformation greater than 1 mm when a force of 30 N is applied at the geometric center of the wall, with a preloading rate of 20 mm/min.

16. The device for packaging and dispensing cosmetic product according to claim 2, wherein the reservoir includes at least one side wall and a bottom, the side wall having a mean lack of springback greater than −8% when a force of 30 N is applied at the geometric center of the wall, with a preloading rate of 20 mm/min.

17. The device for packaging and dispensing cosmetic product according to claim 3, wherein the reservoir includes at least one side wall and a bottom, the side wall having a mean lack of springback greater than −8% when a force of 30 N is applied at the geometric center of the wall, with a preloading rate of 20 mm/min.

18. The device for packaging and dispensing cosmetic product according to claim 4, wherein the reservoir includes at least one side wall and a bottom, the side wall having a mean lack of springback greater than −8% when a force of 30 N is applied at the geometric center of the wall, with a preloading rate of 20 mm/min.

19. The device for packaging and dispensing cosmetic product according to claim 2, wherein the reservoir is made of plastic material selected from polypropylene, polyethylene terephthalate, and high-density polyethylene.

20. The device for packaging and dispensing cosmetic product according to claim 3, wherein the reservoir is made of plastic material selected from polypropylene, polyethylene terephthalate, and high-density polyethylene.
